(19) United States
(12) Patent Application Publication
(10) Pub. No.: US 2008/0276013 A1
(43) Pub. Date: Nov. 6, 2008

(54) Semiconductor Integrated Circuit

(76) Inventors: Akihiko Ohtani, Osaka (JP); Hiroshi Imanishi, Osaka (JP)

Correspondence Address: MCDERMOTT WILL & EMERY LLP, 600 13TH STREET, N.W., WASHINGTON, DC, 20005-3096, US

(21) Appl. No.: 11/629,913

(22) PCT Filed: Feb. 8, 2006
(86) PCT No.: PCT/JP2006/002186

§ 371 Date: Dec. 18, 2006

(30) Foreign Application Priority Data
Apr. 5, 2005 (JP) 2005-108453

(51) Int. Cl. G06F 3/00

(52) U.S. Cl. 710/14

(57) ABSTRACT

Enabling and disabling of a plurality of internal buses (77A, 77B) are determined according to mode information recorded in a mode switching circuit (20) in an LSI, and the LSI is provided with external terminals only for data bus connection corresponding to a requested function, thereby a plurality of external data bus connections are realized by using a single hardware.

### TECHNICAL FIELD

The present invention relates to a semiconductor integrated circuit, and particularly relates to a large scale integrated circuit (LSI) having mode selection capability.

### BACKGROUND ART

The high degree of integration of semiconductors achieved in recent years has enabled realization of high-performance LSIs. In order to achieve high-performance, an LSI frequently sends/receives data externally, and for such frequent external data sending/receiving, it is common to provide multiple data bus connections and increase the data bus width. On the other hand, however, there is a demand for cost reduction. Therefore, conventionally, LSIs having a different number of external terminals corresponding to function realization requests have been individually developed and fabricated.

Furthermore, in order to allow a single LSI to have a plurality of modes and thereby realize different functions, it has been necessary to provide the LSI with a mode selection terminal as an external terminal. Even in the case of an LSI provided with no external mode selection terminal, a complicated procedure has been necessary during actual use, such as generation of mode selection signal according to an electric power supply sequence, for example (see Patent Document 1).

Patent Document 1: Japanese Laid-Open Publication No. 7-30070

### DISCLOSURE OF THE INVENTION

### Problem that the Invention Intends to Solve

As described above, conventionally, it has been necessary to individually develop and fabricate LSIs having a different number of external terminals corresponding to function realization requests. Also, conventionally, in order to allow a single LSI to have a plurality of modes and thereby realize different functions, it has been necessary to provide a mode selection terminal as an external terminal, or a complicated procedure has been necessary during actual use.

It is an object of the present invention to enable the selection of internal bus structure to be easily reflected in the number of external terminals in an LSI having mode selection capability.

### Means for Solving the Problem

In order to solve the above problem, according to the present invention, an LSI is provided with external terminals only for signals that are enabled.

Specifically, an inventive semiconductor integrated circuit includes: a plurality of internal buses; a mode switching circuit for specifying which of the plurality of internal buses is to be enabled; and external terminals provided for an internal bus enabled by the mode switching circuit, wherein an internal bus disabled by the mode switching circuit is not connected to the external terminals.

Enabled internal buses can be connected to respective independent external data buses or to a single external data bus formed of coupled external data buses and thus having a wide bus width.

Also, if a non-volatile memory for retaining information for specifying which of the internal buses is to be enabled is provided in the mode switching circuit, or if the mode switching circuit is provided with a mode selection terminal for specifying an internal bus to be enabled by application of a specific internal potential, no mode selection terminal needs to be provided as an external terminal.

### EFFECTS OF THE INVENTION

According to the present invention, it is possible to easily realize LSIs having a different number of external terminals corresponding to function realization requests by using a single hardware. In addition, disabled signals are not present on the external terminals, thereby allowing cost reduction.

### BRIEF DESCRIPTION OF DRAWINGS

FIG. 1 is a block diagram illustrating an exemplary structure of a semiconductor integrated circuit according to the present invention.

FIG. 2 is a circuit diagram illustrating an exemplary internal structure of one interface circuit shown in FIG. 1.

FIG. 3 is a block diagram illustrating a modified example of a mode switching circuit shown in FIG. 1.

FIG. 4 is a block diagram illustrating a modified example of an internal bus structure shown in FIG. 1.

FIG. 5 is a block diagram illustrating a modified example of an interface structure shown in FIG. 4.

### EXPLANATION OF THE REFERENCE CHARACTERS

20 Mode switching circuit
21 Mode selection terminal
22 Internal potential
30 Non-volatile memory
40 Internal resource write circuit
50 Data processing circuit
60A, 60B Bus control circuits
70A, 70B Data bus connection circuits
75A, 75B Data buses
76A, 76B Transfer control buses
77A, 77B Internal buses
80A, 80B, 80C First interface (IF) circuits
81A, 81B Second interface (IF) circuits
85 Data bus selector
86 Input/output control selector
91 Input driving circuit
92 Output driving circuit
IN1A, IN1B, IN1C First input driving signals
IN2A, IN2B Second input driving signals
MODA, MODB Mode signals
OUT1A, OUT1B, OUT1C First output driving signals
OUT2A, OUT2B Second output driving signals
RWA, RWB Read/write signals

### BEST MODE FOR CARRYING OUT THE INVENTION

Hereinafter, embodiments of the present invention will be described with reference to the accompanying drawings.

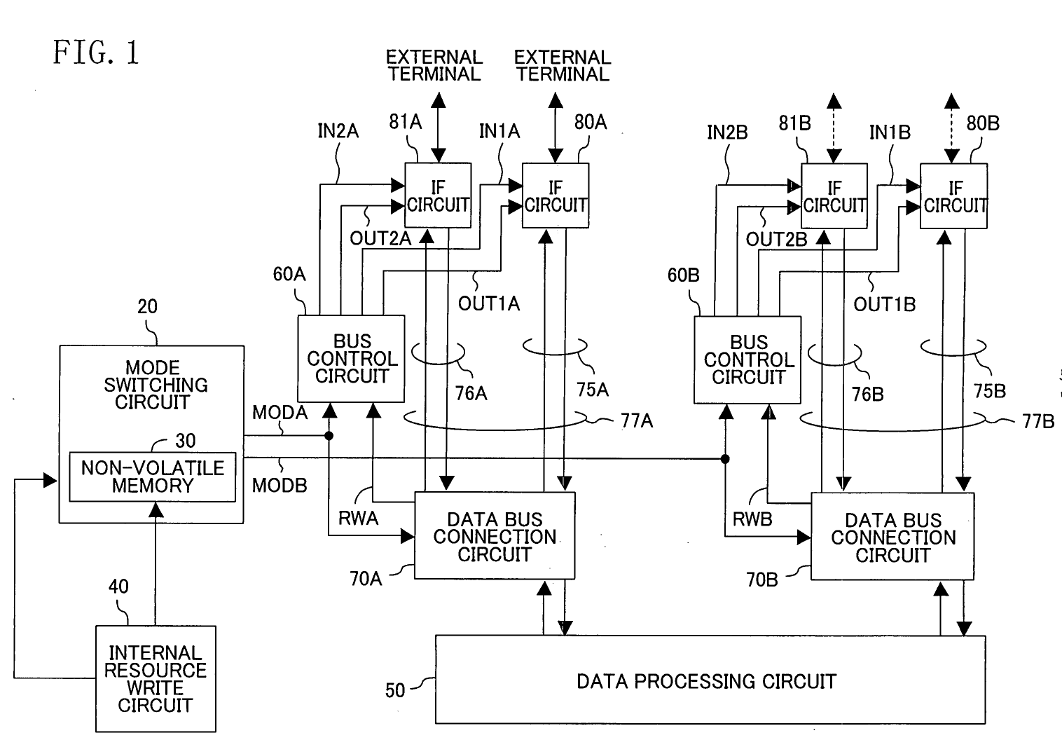

FIG. 1 illustrates an exemplary structure of an LSI according to the present invention. This LSI is a component after the packaging of a semiconductor chip and is provided with a certain number of external terminals. In FIG. 1, the reference numeral 20 refers to a mode switching circuit; 30 to a non-volatile memory; 40 to an internal resource write circuit; 50 to a data processing circuit; 60A and 60B to bus control circuits; 70A and 70B to data bus connection circuits; 75A and 75B to data buses; 76A and 76B to transfer control buses for controlling data transfers on the data buses 75A and 75B; 80A and 80B to first interface (IF) circuits for connecting the data buses 75A and 75B to external terminals; and 81A and 81B to second IF circuits for connecting the transfer control buses 76A and 76B to external terminals. The data bus 75A and the transfer control bus 76A form a first internal bus (bus A) 77A, while the data bus 75B and the transfer control bus 76B form a second internal bus (bus B) 77B.

The LSI shown in FIG. 1 includes the transfer control buses 76A and 76B for the two data buses 75A and 75B, respectively. That is, the exemplary structure shown in FIG. 1 allows the LSI to control the two data buses 75A and 75B in different ways.

The mode switching circuit 20 includes the non-volatile memory 30 for retaining mode information for specifying one of a plurality of modes, and the mode information is recorded on the non-volatile memory 30 by the internal resource write circuit 40 during the time between the fabrication process of the LSI and the shipping process thereof. In accordance with the recorded mode information, the mode switching circuit 20 supplies a mode signal MODA to the bus control circuit 60A and the data bus connection circuit 70A and supplies a mode signal MODB to the bus control circuit 60B and the data bus connection circuit 70B.

FIG. 1 shows an example in which the mode signal MODA indicates permission for the operation of the data bus connection circuit 70A and of the first internal bus 77A connected thereto, while the mode signal MODB indicates prohibition of the operation of the data bus connection circuit 70B and of the second internal bus 77B connected thereto. Therefore, external terminals are provided only to the first and second IF circuits 80A and 81A of the bus A.

Read/write signals RWA and RWB that the data bus connection circuits 70A and 70B output are signals indicating whether to read or write data. Herein, data input from the external terminals into the LSI is called read, and data output from the LSI to the external terminals is called write. IN1A and IN1B refer to first input driving signals, OUT1A and OUT1B refer to first output driving signals, IN2A and IN2B refer to second input driving signals, and OUT2A and OUT2B refer to second output driving signals.

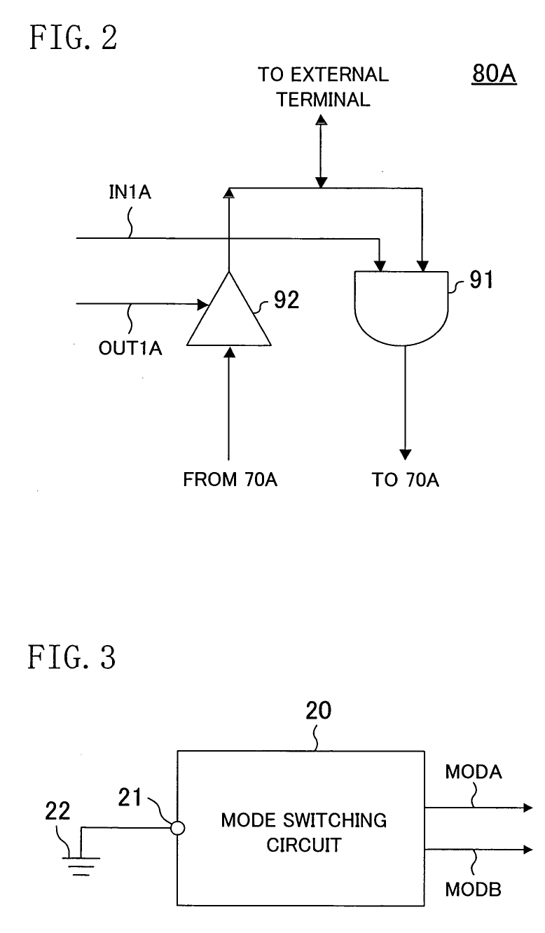

FIG. 2 illustrates an exemplary internal structure of the IF circuit 80A, which is one of the IF circuits shown in FIG. 1. In FIG. 2, the reference numeral 91 refers to an input driving circuit which is an AND gate, and the reference numeral 92 refers to an output driving circuit which is a tri-state buffer. The other three IF circuits 80B, 81A and 81B have the same structure as that shown in FIG. 2.

The data bus connection circuit 70A, which is permitted to operate, provides the first IF circuit 80A with the first input driving signal IN1A and the first output driving signal OUT1A and provides the second IF circuit 81A with the second input driving signal IN2A and the second output driving signal OUT2A through the bus control circuit 60A. In the state in which the mode signal MODA permits the first internal bus 77A to operate, these signals are controlled by the read/write signal RWA from the data bus connection circuit 70A.

When the read/write signal RWA indicates read, the input driving signals IN1A and IN2A and the output driving signals OUT1A and OUT2A are controlled by the bus control circuit 60A so that the input driving signals IN1A and IN2A show the H level and the output driving signals OUT1A and OUT2A show the L level. This results in input operation from the external terminals. That is, the output of the input driving circuit 91 shown in FIG. 2 is a value from one of the external terminals, i.e., a value supplied to the data processing circuit 50 through the data bus connection circuit 70A. On the other hand, the output of the output driving circuit 92 does not depend on a value from the data bus connection circuit 70A and is in a high impedance state.

When the read/write signal RWA indicates write, the input driving signals IN1A and IN2A and the output driving signals OUT1A and OUT2A are controlled by the bus control circuit 60A so that the input driving signals IN1A and IN2A show the L level and the output driving signals OUT1A and OUT2A show the H level. This results in output operation to the external terminals. That is, the output of the input driving circuit 91 shown in FIG. 2 does not depend upon a value from the external terminals and is fixed at the L level, such that the signal logic to the data bus connection circuit 70A and to the data processing circuit 50 is fixed. On the other hand, the output of the output driving circuit 92 is a value supplied from the data processing circuit 50 through the data bus connection circuit 70A.

The data bus connection circuit 70B, which is prohibited from operating, provides the first IF circuit 80B with the first input driving signal IN1B and the first output driving signal OUT1B and provides the second IF circuit 81B with the second input driving signal IN2B and the second output driving signal OUT2B through the bus control circuit 60B. In the state in which the mode signal MODB prohibits the second internal bus 77B from operating, these signals are not dependent on the read/write signal RWB and are controlled by the bus control circuit 60B so that the input driving signals IN1B and IN2B and the output driving signals OUT1B and OUT2B each show the L level according to the mode signal MODB. As a result, the output of the input driving circuit 91 shown in FIG. 2 does not depend on a value from the external terminals and is fixed at the L level, such that the signal logic to the data bus connection circuit 70B and to the data processing circuit 50 is fixed. In this manner, the signal logic to the circuit that is not to be operated is fixed, thereby achieving low power consumption. On the other hand, the output of the output driving circuit 92 does not depend on a value from the data bus connection circuit 70B and is in a high impedance state, whereby adverse effect on outer circuits can be prevented beforehand.

In a case in which, of the buses A and B, only the latter is enabled, external terminals are provided only for the first and second IF circuits 80B and 81B of the bus B, the mode signal MODA indicates prohibition of the operation of the data bus connection circuit 70A and of the first internal bus 77A connected thereto, and the mode signal MODB indicates permission for the operation of the data bus connection circuit 70B and of the second internal bus 77B connected thereto. Also, in a case in which the buses A and B are both enabled, external terminals are provided for both the buses A and B, and the mode signals MODA and MODB both indicate the operation permission.

As mentioned above, in the LSI described with reference to FIGS. 1 and 2, the external terminals only for the data bus connection according to function realization requests are provided. For example, when connection with a hard disk drive is only requested, external terminals are provided only for the bus A; when connection with an optical disc drive is only requested, external terminals are provided only for the bus B; and when connection with both the hard disk drive and the optical disc drive is requested, external terminals are provided for both the buses A and B. That is, the three types of LSIs are offered to users, even though a single semiconductor chip is used in the fabrication process. In addition, since the mode signals MODA and MODB are generated from the information stored in the non-volatile memory 30, no external mode selection terminals are necessary, thereby reducing costs.

It should be noted that the supply of data and control signals to the internal resource write circuit 40 is usually made by using the common terminals used in the inspection of the shipping process and thus does not cause increase in the number of external terminals.

FIG. 3 illustrates a modified example of the mode switching circuit 20 shown in FIG. 1. The mode switching circuit 20 shown in FIG. 3 determines the mode in accordance with an input from a mode selection terminal 21, which is one of the internal terminals within the LSI package. More specifically, at the time when the semiconductor chip is mounted on the LSI, the mode selection terminal 21 is fixed at a specific internal potential 22, such as a power supply voltage or a ground on the LSI, whereby the mode switching circuit 20 determines the mode. The mode switching circuit 20 outputs the mode signals MODA and MODB corresponding to the mode determined by the internal potential 22. This also eliminates the need for providing a mode selection terminal as an external terminal of the LSI, which allows cost reduction. This modified example is effective in cases, such as in BGA (Ball Grid Array), in which a semiconductor chip is connected to external terminals through a printed board.

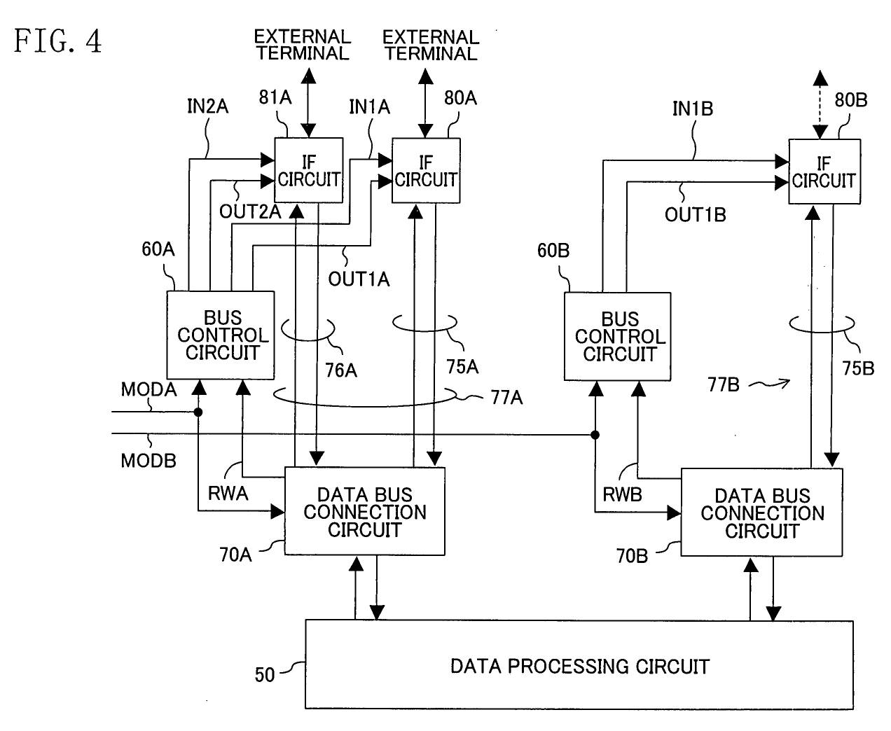

FIG. 4 illustrates a modified example of the internal bus structure shown in FIG. 1. In this modified example, the transfer control bus 76B shown in FIG. 1 is not provided. Specifically, in FIG. 4, the data bus 75A and the transfer control bus 76A form the first internal bus (bus A) 77A, while only the data bus 75B forms the second internal bus (bus B) 77B, such that the transfer control bus 76A is shared by the buses A and B. In other words, this structure allows the LSI to use both the data buses 75A and 75B by the same control.

In the LSI shown in FIG. 4, external terminals having a data width corresponding to a function realization request can be provided, whereby costs can be reduced. For example, when data connection to a 16-bit width external memory is requested, external terminals are provided only for the bus A, and when data connection to a 32-bit width external memory is requested, external terminals are provided for both the buses A and B. Memory address signals, and memory control signals are sent/received through the external terminals provided for to the second IF circuit 81A. That is, the two types of LSIs are offered to users, even though a single semiconductor chip is used in the fabrication process.

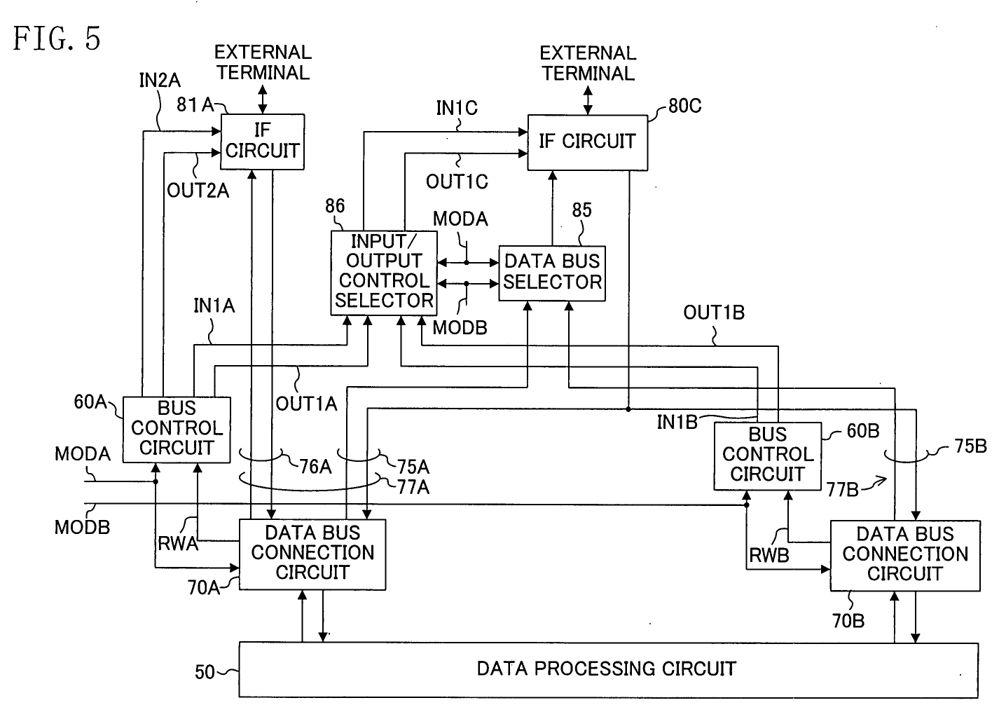

FIG. 5 illustrates a modified example of the interface structure shown in FIG. 4. In this modified example, a first IF circuit 80C is shared by the buses A and B. Therefore, a data bus selector 85 and an input/output control selector 86 are added. The data bus selector 85 selects part of the data bus 75A belonging to the first internal bus 77A, when the two mode signals MODA and MODB indicate permission for the operation of the bus A and prohibition of the operation of the bus B, and selects part of the data bus 75B belonging to the second internal bus 77B, when the two mode signals MODA and MODB indicate prohibition of the operation of the bus A and permission for the operation of the bus B. The data bus selector 85 then connects the selected bus to the first IF circuit 80C. The input/output control selector 86 selects the first input driving signal IN1A and the first output driving signal OUT1A received from the bus control circuit 60A, when the two mode signals MODA and MODB indicate permission for the operation of the bus A and prohibition of the operation of the bus B, and selects the first input driving signal IN1B and the first output driving signal OUT1B received from the bus control circuit 60B, when the two mode signals MODA and MODB indicate prohibition of the operation of the bus A and permission for the operation of the bus B. The input/output control selector 86 then connects the selected signals (IN1C and OUT1C) to the first IF circuit 80C. External terminals are necessarily provided to the first IF circuit 80C irrespective of which of the buses A and B is permitted to operate.

In the LSI shown in FIG. 5, it is possible to properly use the external terminals depending on the type of data. For example, when results of the first one of a plurality of processings performed in the data processing circuit 50 should be output to the external terminals, the operation of the bus A is permitted, and when results of the second one of the processings should be output to the external terminals, the operation of the bus B is permitted. That is, the two types of LSIs are offered to users, even though a single semiconductor chip is used in the fabrication process.

In the foregoing descriptions, the two internal buses, i.e., the buses A and B, are present in the LSI, but the present invention is obviously applicable to an LSI including three or more internal buses.

### INDUSTRIAL APPLICABILITY

As described above, the semiconductor integrated circuits according to the present invention can easily realize LSIs having a different number of external terminals corresponding to function realization requests by using a single hardware, and are thus particularly applicable to LSIs having mode selection capability and the like.

1. A semiconductor integrated circuit comprising:
a plurality of internal buses;
a mode switching circuit for specifying which of the plurality of internal buses is to be enabled; and
external terminals provided for an internal bus enabled by the mode switching circuit,
wherein an internal bus disabled by the mode switching circuit is not connected to the external terminals.

2. The semiconductor integrated circuit of claim 1, wherein each of the plurality of internal buses includes a data bus and a transfer control bus for controlling data transfer on the data bus.

3. The semiconductor integrated circuit of claim 1, wherein at least one of the plurality of internal buses includes a data bus and a transfer control bus for controlling data transfer on the data bus, and
the other internal bus or buses include a data bus whose data transfer is controlled in common by the transfer control bus.

4. The semiconductor integrated circuit of claim 1, wherein the mode switching circuit includes a non-volatile memory for retaining information for specifying which of the plurality of internal buses is to be enabled.

5. The semiconductor integrated circuit of claim 1, wherein the mode switching circuit includes a mode selection terminal for specifying, by being subjected to application of a specific internal potential, which of the plurality of internal buses is to be enabled.

6. The semiconductor integrated circuit of claim 1, further comprising an interface circuit for providing a signal having a fixed logic to the internal bus disabled by the mode switching circuit.

7. The semiconductor integrated circuit of claim 1, further comprising an interface circuit for disabling output drive of the internal bus disabled by the mode switching circuit.

8. The semiconductor integrated circuit of claim 1, further comprising a selector for selecting, from the plurality of internal buses, the internal bus enabled by the mode switching circuit, and
an interface circuit for connecting the internal bus selected by the selector to the external terminals.
